(19) United States
(12) Patent Application Publication
(10) Pub. No.: US 2008/0094539 A1
(43) Pub. Date: Apr. 24, 2008

(54) Liquid crystal display with black/white liquid crystal display panel

(75) Inventors: Man-Ho Kim, Suwon-si (KR); Joong-Wan Park, Suwon-si (KR); Seong-Ha Park, Suwon-si (KR)

Correspondence Address: CHA & REITER, LLC, 210 ROUTE 4 EAST STE 103, PARAMUS, NJ, 07652, US

(73) Assignee: Samsung Electronic Co., LTD.

(21) Appl. No.: 11/904,664

(22) Filed: Sep. 28, 2007

(30) Foreign Application Priority Data
Oct. 20, 2006 (KR) 2006-102298

(51) Int. Cl. G02F 1/13357; G02F 1/1335

(52) U.S. Cl. 349/64; 349/106

(57) ABSTRACT

A liquid crystal display device includes a black-white liquid crystal display panel including a liquid crystal layer for displaying an image, a color filter disposed under the black-white liquid crystal panel, filtering inputted light to produce a preset color and outputting filtered light to the black-white liquid crystal display panel.

### CLAIM OF PRIORITY

This application claims the benefit of the earlier filing date, under 35 U.S.C. § 119(a), to that patent application entitled “Liquid Crystal Display With Black/White Liquid Crystal Display Panel” filed in the Korean Industrial Property Office on Oct. 20, 2006 and assigned Serial No. 2006-102298, the contents of which are hereby incorporated by reference.

### BACKGROUND OF THE INVENTION

1. Field of the Invention

The present invention relates to a liquid crystal display, and more particularly, to the liquid crystal display using a black-white LCD panel.

2. Description of the Related Art

The liquid crystal display (LCD) has been developed for replacing a cathode ray tube (CRT) on the basis of advantages such as low voltage drive and low power consumption. Particularly, since a thin film transistor LCD (TFT-LCD) can attain high quality and enlargement of display and colorfulness, all of which are equivalent to those of the CRT, the TFT-LCD is being widely used in the field of a portable wireless terminals (e.g, cellular phones, laptop computers, video cameras, PDAs, etc.).

The LCD device includes an LCD panel having a liquid crystal layer for displaying an image, and a backlight unit (BLU) for providing the LCD panel with light. The LCD panel includes the liquid crystal layer and upper and lower glass substrates disposed on upper and lower sides of the liquid crystal layer for controlling the arrangement of liquid crystal molecules. The lower glass substrate includes the thin film transistors and pixel electrodes, and the upper glass substrate includes common electrodes. The LCD panel further includes upper and lower polarization panels disposed on the upper and lower sides of the liquid crystal layer for linearly polarizing the inputted light. In the illustrated case herein, polarizing direction of the upper polarization panel is perpendicular to that of the lower polarization panel.

Conventionally, the LCD panels are classified into a color LCD panel and a black-white LCD panel, depending on whether the upper glass substrate further includes a color filter in addition to the common electrodes. In the black-white LCD panel, the color of the inputted light does not change, because there is not included a color filter. Also, an RGB LCD device includes the color LCD panel installed with a RGB color filter, wherein the RGB LCD device makes it possible to attain desired colors within the pixel units.

FIG. 1 illustrates a black-white LCD panel included in a conventional LCD device. The LCD device includes the black-white LCD panel 100 and a backlight unit (not shown) for inputting mono-color input light 140 to the black-white panel 100. The mono-color input light 140 is obtained by mixing red (R), green (G) and blue (B) lights. The backlight unit may include red-, green- and blue-light diodes. As illustrated in the drawing, amber light (A) is obtained by combining the red-, the green- and the blue-lights outputted from the red-, the green- and blue-light diodes together in known ratios. In FIG. 1, although the input light 140 is indicated with R(red), G(green) and B(blue) and output light 150 is indicated with A (amber) for the sake of convenience in understanding.

The black-white LCD panel 100 includes a liquid crystal layer 110, upper and lower glass substrates 120 and 125 for controlling arrangement of liquid crystal molecules; and upper and lower polarization panels 130 and 135 for linear polarization. The lower glass substrate 125 have thin film transistors and pixel electrodes, while the upper glass substrate 120 includes common electrodes. In the black-white LCD panel 100, electric field is applied to the liquid crystal molecules using the thin film transistors and the pixel electrodes, and the arrangement of the liquid crystal molecules is changed by means of the electric field, so that the intensity of the output light 150 from the LCD panel 100 is controlled. The upper and lower polarization panels 130 and 135 linearly polarize the respectively inputted lights and the polarization directions of the upper and lower polarization panels 130 and 135 are substantially orthogonal to each other.

The LCD panel as described above includes an advantage in that a preset color image may be attained using the black-white LCD panel, is less expensive and simpler to manufacture than a color LCD panel. However, there are problems in that the red, green and blue LEDs are expensive, complex driving circuit is required due to different driving properties of these LEDs, and the power consumption is higher.

### SUMMARY OF THE INVENTION

Accordingly, the present invention has been made to solve the above-mentioned problems occurring in the prior art, and the present invention provides a liquid crystal display device capable of attaining cheaper price, simpler driving circuit and lower power consumption than a conventional one, while a preset color image is attained using a black-white liquid crystal display panel.

In accordance with an aspect of the present invention, there is provided a liquid crystal panel device including a black-white liquid crystal display panel including a liquid crystal layer and displaying image and a color filter disposed under the black-white liquid crystal display panel for filtering input light to thereby produce a preset color and for outputting filtered light to the black-white liquid crystal display panel.

### BRIEF DESCRIPTION OF THE DRAWINGS

The above and other aspects, features and advantages of the present invention will be more apparent from the following detailed description taken in conjunction with the accompanying drawings, in which:

FIG. 1 is a black-white liquid crystal display panel according to an LCD device of prior art;

FIG. 2 is a liquid crystal display portion of an LCD device according to the present invention;

FIG. 3 is a liquid crystal display device according to a first embodiment of the present invention; and

FIG. 4 is a liquid crystal display device according to a second embodiment of the present invention.

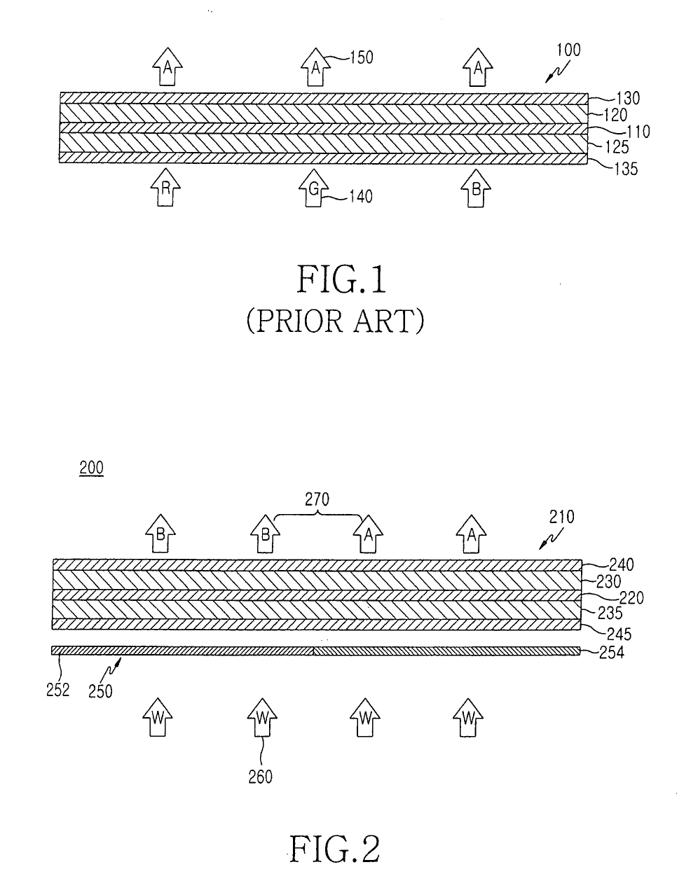

### DETAILED DESCRIPTION OF THE INVENTION

Hereinafter, exemplary embodiments of the present invention will be described with reference to the accompanying drawings. In the following description, a detailed description of known functions and configurations incorporated herein will be omitted when it may make the subject matter of the present invention rather unclear.

FIG. 2 is a liquid crystal display portion of a LCD device according to the present invention. The LCD device includes a liquid crystal display portion 200 for displaying image and a backlight unit (not shown) for outputting white (W) light 260. The liquid crystal display portion 200 includes: a black-white liquid crystal display panel 210 including a liquid crystal layer and displaying the image; and a color filter 250 for filtering the white light inputted from the backlight unit to thereby produce a preset color and for outputting filtered light to the black-white liquid crystal display panel 210.

The color filter 250 is disposed under the black-white liquid crystal display panel 210 with a distance there-between. The color filter 250 includes a first and a second filter portions 252 and 254 in such a manner that each of their side edges are bonded to each other to thereby bisect the whole area of the color filter. The first filter portion 252 allows only blue light (B) to pass there-through, while the second filter portion 254 allows only amber light (A) to pass there-through. The color filter 250 filters the inputted white light 260 in a bisectional manner and outputs filtered light to the black-white liquid crystal display panel 210. As the black-white liquid crystal panel 210 allows the inputted light to pass there-through without any color change, the light 270 outputted from the black-white liquid crystal panel 210 is bisected to the blue color and the amber color, so that the black-white liquid crystal panel 210 displays a bisected image thereon.

The black-white liquid crystal display panel 210 includes a liquid crystal layer 220; upper and lower glass substrates 230 and 235 for controlling the arrangement of liquid crystal molecules; and upper and lower polarization panels 240 and 245 for linear polarization.

The lower glass substrate 235 is directly disposed on a lower surface of the liquid crystal layer 220 and includes thin film transistors and pixel electrodes. The upper glass substrate 230 is disposed on an upper surface of the liquid crystal layer 220 and includes common electrodes. In the black-white liquid crystal display panel 210, an electric field is applied to liquid crystal molecules using the thin film transistors and the pixel electrodes, and the arrangement of the liquid crystal molecules is changed by means of the electric field, so that the intensity of the light 270 outputted from the black-white liquid crystal display panel 210 is controlled.

The upper polarization panel 240 is directly disposed on an upper surface of the upper glass substrate 230 and the lower polarization panel 245 is directly disposed on a lower surface of the lower glass substrate 235. Each of the upper and lower polarization panels 240 and 245 linearly polarizes the inputted light and the polarization directions of the upper and lower polarization panels 240 and 245 are orthogonal to each other.

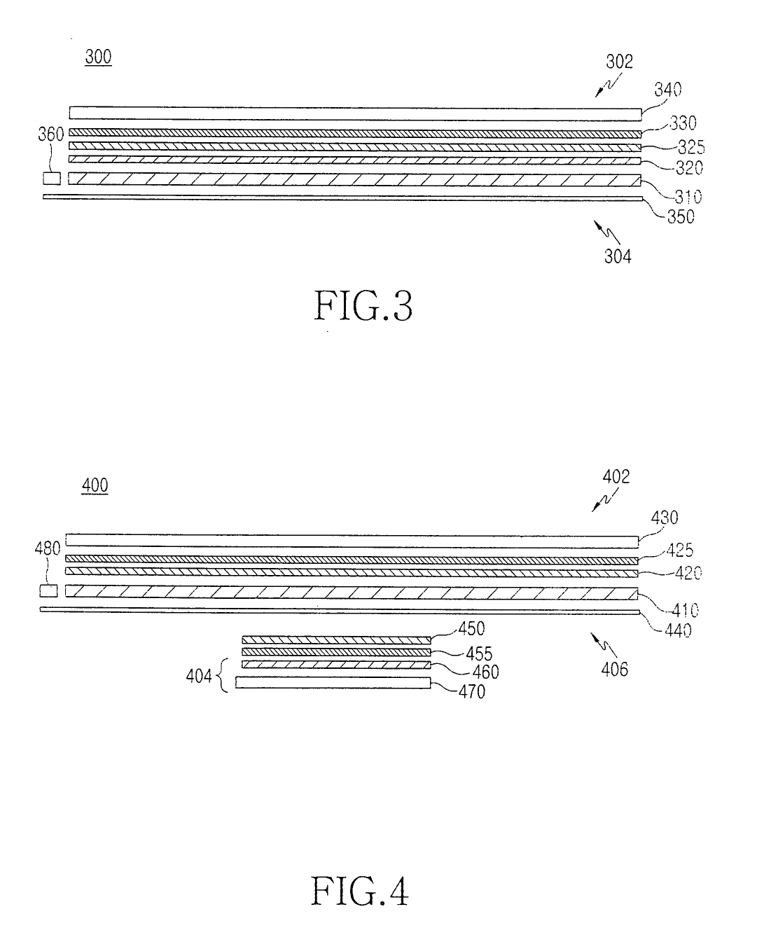

FIG. 3 is a liquid crystal display device according to a first embodiment of the present invention. A liquid crystal display panel 340 included in the liquid crystal display device 300 has almost the same construction as the black-white liquid crystal display panel 210 as shown in FIG. 2, thus the detailed description thereof will be omitted.

The liquid crystal display device 300 displays an image in an uni-direction (such a liquid crystal display device is typically referred to as “one-way LCD”) and includes a liquid crystal display portion 302 for displaying the image and a backlight unit 304 for outputting white light. The liquid crystal display portion 302 includes a black-white liquid crystal display panel 340 including a liquid crystal layer and displaying the image and a color filter 330 for filtering the white light inputted from the backlight unit 304 to produce a preset color and for outputting filtered light to the black-white liquid crystal display panel 340.

The backlight unit 304 includes a light source 360 for outputting the white light, a light guide panel 310 for illuminating the black-white liquid crystal display panel 340 while guiding the light coupled from the light source 360 through internal reflection, a reflection panel 350 for reflecting the light outputted from the light guide panel 310, a diffusion panel 320 and a prism sheet 325.

The light source 360 may include a light emitting diode, a laser diode (LD), etc.

The light guide panel 310 has an upper surface and a lower surface opposed to each other and first through fourth side edges. Here, the first side edge faces a illumination face of the light source 360. The light guide panel 310 guides the light, which is internally coupled through the first side edge toward the second side edge, opposed to the first side edge, through the internal reflection. The light guide panel 310 includes a number of dot patterns which are uniformly formed over the lower surface thereof. Some of the light scattered by each of the dot patterns reflects toward the upper surface of the light guide panel 310, while the remainder of the scattered light is transmitted through the lower surface of the light guide panel 310. In other words, each of the dot patterns breaks the condition for the total internal reflection, so that the light scattered or diffuse reflected by each of the dot patterns is transmitted through the upper and lower surfaces of the light guide panel 310.

Each of the dot patterns includes a circular form, an oval form, a rectangular form, a diamond form, etc. There is either intaglio (i.e., in the form of a recess) or relief (i.e. in the form of a boss) formed on the lower surface of the light guide panel 310. Also, it is possible to separately form each of the dot patterns in the shape of respective protrusion and then to attach the dot patters to the lower surface of the light guide panel. In one aspect, each of the dot patterns is embodied in the form of hemispheric recess. If necessary, each of the dot patterns is embodied in the form of pattern for diffused reflection, such as scratches.

As the light incident into the light guide panel 310 is attenuated while it proceeds from the first side edge adjacent to the light source 360 to the second side edge, the brightness appeared on the upper surface of the light guide panel 310 may be distributed in such a manner that it is gradually reduced from the first side edge to the second side edge. In order to solve this non-uniformity of light, density of the dot patterns may gradually increase from the first side edge to the second side edge. Here, the density change in the dot patterns may be attained by changing either the number or the size of the dot pattern. The density of the dot pattern is defined as an area occupied by the dot pattern per an unit area.

The reflection panel 350 is disposed in such a manner that an upper surface thereof faces a lower surface of the light guide panel 310 with a distance there-between. The reflection panel 350 reflects the light transmitted through a lower surface of the light guide panel 310 to thereby input the light into the light guide panel 310 again. It is preferable that the reflection panel 350 has reflectivity of about 100%, but it may have lower reflectivity than 100% as necessary.

The diffusion panel 320 is disposed in such a manner that a lower surface thereof faces an upper surface of the light guide panel 310 with a distance there-between and that it scatters and transmits the light inputted from the light guide panel 310.

The prism sheet 325 is disposed in such a manner that a lower surface of a prism substrate faces an upper surface of the diffusion panel 320 with a distance there-between. The prism sheet 325 includes the prism substrate and a plurality of prism hills protruded from an upper surface of the prism substrate. The prism sheet 325 serves to collimate and transmit the light inputted from the diffusion panel 320.

The color filter 330 is disposed in such a manner that a lower surface thereof faces an upper surface of the prism sheet 325 with a distance there-between. The color filter 330 transmits only the light of a preset color. The color filter 330 filters the white light inputted from the prism sheet 325 to produce the preset color, and then outputs the filtered light to the black-white liquid crystal display panel 340. Since the light inputted to the black-white liquid crystal display panel 340 is transmitted there-through without changing the color, the black-white liquid crystal display panel 340 displays the image with the preset color on the upper surface thereof.

The black-white liquid crystal panel 340 includes a liquid crystal layer, upper and lower glass layers for controlling the arrangement of liquid crystal molecules and upper and lower polarization panels for linear polarization.

FIG. 4 is a liquid crystal display device according to a second embodiment of the present invention. The liquid crystal display device 400 has a structure similar to that of the liquid crystal display device 300 except that the a second diffusion panel 450, a second prism sheet 455 and a second liquid crystal display panel 470 are included in the liquid crystal display device 400. Accordingly, the detailed description of similar components will be omitted.

The liquid crystal display device 400 displays images in two directions (such liquid crystal display device is typically referred to as “two-way LCD”) and includes a first and a second liquid crystal display portions 402 and 404 for displaying the images and a backlight unit 406 for outputting white light. The first liquid crystal display portion 402 includes a first black-white liquid display panel 430 with a liquid crystal layer for displaying the image. The second liquid crystal display portion 404 includes a second black-white liquid crystal display panel with a liquid crystal layer for displaying image and a color filter 460 for filtering white light imputed from the backlight unit 406 to thereby produce light of a preset color and outputting the filtered light to the second black-white liquid crystal display panel 470.

The backlight unit 406 includes a light source 480 for outputting the white light, a light guide panel 410 for illuminating the first and the second black-white liquid crystal display panels 430 and 470 while guiding the light internally coupled from the light source 480 through the internal reflection, a reflection panel 440 for reflecting the light outputted from the light guide panel 410 toward the light guide panel 410, a first and a second diffusion panels 420 and 450; and a first and a second prism sheets 425 and 455.

The light guide panel 410 has an upper surface and a lower surface opposed to each other, and a first through fourth side edges. Here, the first side faces the light source 480. The light guide panel 410 guides the light, which is internally coupled from the first side edge toward the second side edge opposite to the first side edge through the internal reflection. The light guide panel 410 has a plurality of dot patterns, which are uniformly formed over an entire area of the lower surface thereof. A portion of the light scattered by the dot patterns reflects to the upper surface of the light guide panel 410 and the remaining light scattered is transmitted through the lower surface of the light guide panel 410. In other words, each of the dot patterns breaks the condition for total reflection, so that the light scattered by each of the dot patterns is transmitted through the upper and lower surfaces of the light guide panel 410.

The reflection panel 440 is disposed in such a way that an upper surface thereof faces a lower surface of the light guide panel 410 with a distance there-between. The reflection panel 440 reflects a portion of the light transmitted through the lower surface of the light guide panel 410, so that the portion of the light is inputted into the light guide panel 410 again, while the remainder of the light is inputted into the second diffusion panel 450. It is preferable that the reflection panel 440 has reflectivity of about 50 to 80%.

The diffusion panel 450 is disposed in such a manner that a lower surface thereof faces an upper surface of the light guide panel 410 with a distance there-between and that it scatters and transmits the light inputted from the light guide panel 410.

The prism sheet 425 is disposed in such a manner that a lower surface of a prism substrate faces an upper surface of the first diffusion panel 420 with a distance there-between. The prism sheet 425 includes the prism substrate and a plurality of prism hills protruded from an upper surface of the prism substrate. The first prism sheet 425 serves to collimate and transmit the light inputted from the diffusion panel 420.

The first black-white liquid crystal display panel 430 includes a liquid crystal layer, upper and lower glass layers for controlling the arrangement of liquid crystal molecules and upper and lower polarization panels for the linear polarization. Since the light inputted from the first prism sheet 425 to the first black-white liquid crystal panel 430 is transmitted without color change, the first black-white liquid crystal panel 430 displays an image having white color on an upper surface thereof.

The second diffusion panel 450 is disposed in such a manner that a lower surface thereof faces a lower surface of the reflection panel 440 with a distance there-between. The second diffusion panel 450 scatters and transmits the light inputted from the light guide panel 410.

The second prism sheet 455 is disposed in such a manner that an upper surface of a prism substrate faces a lower surface of the second diffusion panel 450 with a distance there-between. The second prism sheet 455 has the prism substrate and a plurality of hills protruded from an upper surface of the prism substrate. The second prism sheet 455 serves to collimate and transmit the light inputted from the second diffusion panel 450.

The color filter 460 is disposed in such a manner that an upper surface thereof faces a lower surface of the second prism sheet 455 with a distance there-between. The color filter 460 allows the light with a preset color to be transmitted there-through. The color filter 460 filters the white light inputted from the second prism sheet 455 to thereby produce a preset color and outputs filtered light to the second black-white liquid crystal display panel 470. Since the light inputted to the second black-white liquid crystal display panel 470 is transmitted there-through without color change, the second black-white liquid crystal display panel 470 displays an image with a preset color on a lower surface thereof.

The second black-white liquid crystal display panel 470 is disposed in such a manner that an upper surface thereof faces a lower surface of the color filter. The second black-white liquid crystal display panel 470 includes a liquid crystal layer, upper and lower glass layers for controlling the arrangement of liquid crystal molecules and upper and lower polarization panels for the linear polarization.

The liquid crystal display device according to the present invention can provide the image having a number of colors. For instance, the liquid crystal display device can display a black-white color image, an yellow color image, a purple color image, an amber color image, a bluish green color image or a bisected color image with bluish green and amber.

As described herein before, the liquid crystal display device of the present invention provides the advantages as listed below.

First, it is possible to attain the image with the preset color using the black-white liquid crystal display panel, of which price is lower than that of the color liquid crystal display panel and having a manufacturing process simpler than that of a color crystal display panel.

Second, manufacturing is available with a lower cost and a simpler structure because the light source outputting the white light is used. If the light guide panel is used, it is possible to reduce the number of the light sources (typically, two or three light sources are used). Also, even when a plurality of the light sources directly illuminate the black-white liquid crystal display, the manufacturing is available with a lower cost, since the white light source is significantly cheaper than the color light source. In addition, if the same white light sources are used, there is the advantage in that a simpler drive circuit is needed compared to the case in which RGB light sources are used.

Third, there is the advantage in that the overall power consumption can be reduced compared to the conventional one, because the power consumption in the white light source is lower than that in the color light source.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A liquid crystal display device comprising:
a black-white liquid crystal display panel including a liquid crystal layer; and
a color filter disposed under the black-white liquid crystal panel, for filtering an inputted light to produce a preset color and outputting said filtered light of said preset color to the black-white liquid crystal display panel.

2. The liquid crystal display device as claimed in claim 1, wherein the black-white liquid crystal display panel comprises:
upper and lower glass layers for controlling an arrangement of liquid crystal molecules; and
upper and lower polarization panels for the linear polarization.

3. The liquid crystal display device as claimed in claim 1, further comprising:
a backlight unit for outputting white light to the color filter.

4. The liquid crystal display device as claimed in claim 3, wherein the backlight unit comprises:
a light source for outputting a substantially white light; and
a light guide panel for illuminating the black-white liquid crystal panel display
panel by guiding the light internally through total internal reflection from the light source.

5. The liquid crystal display device as claimed in claim 4, wherein the backlight unit further comprises:
a reflection panel for reflecting the light inputted from light guide panel toward the light guide panel;
a diffusion panel scattering and transmitting the light inputted from the light guide panel; and
a prism sheet collimating and transmitting the light inputted from the diffusion panel.

6. The liquid crystal display device as claimed in claim 1, wherein the color filter comprises:
a plurality of color filter sections for transmitting respective preset colors, wherein the color sections are bonded to each other.

7. A display panel comprising:
a white light source;
a color filter receiving light from said white light source, said filter composed of a plurality color filter sections, each section filtering a white light received from said white light source into a light of a predetermined color; and
a black-white LCD panel receiving each of said lights of a predetermined color.

8. The display panel of claim 7, wherein said predetermined color is selected from the group consisting of: red, green and blue.

9. The display panel of claim 7, wherein said white light source further comprises:
a light generator;
a light guide panel for guiding a white light from said light generator internally through total internal reflection from the light generator.
a reflection panel for reflecting the inputted light toward the light guide panel;
a diffusion panel scattering and transmitting the light inputted from the light guide panel; and
a prism sheet collimating and transmitting the light inputted from the diffusion panel.

10. The display panel of claim 9, further comprising:
means for diffusing light within said light guiding panel.

11. The display panel of claim 10, wherein said means for diffusing light comprises:
a plurality of dot patterns on said light guiding panel, wherein a density of said dot patterns increases in the direction of light propagation.

12. The display panel of claim 11, wherein said density is increased to maintain substantially uniform light distribution.

13. The display panel of claim 7, wherein said LCD panel is comprises:
upper and lower glass layers for controlling an arrangement of liquid crystal molecules; and
upper and lower polarization panels for the linear polarization.

14. The display panel of claim 13, wherein said upper and lower polarization panels are arranged so their respective polarizations are substantially perpendicular.

15. The display panel of claim 9, further comprising:
a second color filter receiving light from said white light source, said filter composed of a plurality color filter sections, each section filtering a white light received from said white light source into a light of a predetermined color; and
a second black-white LCD panel receiving each of said lights of a predetermined color, wherein said second color filter and second black-white LCD panel are positioned oppositely to said reflection panel.

16. The display panel of claim 15, wherein said reflection panel is partially reflective.
